(19) United States
(12) Patent Application Publication
(10) Pub. No.: US 2023/0097606 A1
(43) Pub. Date: Mar. 30, 2023

(54) SYSTEM, DEVICE, METHOD AND PROGRAM THAT PREDICT COMMUNICATION QUALITY

(71) Applicant: NIPPON TELEGRAPH AND TELEPHONE CORPORATION, Tokyo (JP)

(72) Inventors: Kahoko TAKAHASHI, Musashino-shi, Tokyo (JP); Riichi KUDO, Musashino-shi, Tokyo (JP); Takeru INOUE, Musashino-shi, Tokyo (JP); Kohei MIZUNO, Musashino-shi, Tokyo (JP)

(73) Assignee: NIPPON TELEGRAPH AND TELEPHONE CORPORATION, Tokyo (JP)

(21) Appl. No.: 17/802,029

(22) PCT Filed: Feb. 25, 2020
(86) PCT No.: PCT/JP2020/007363

§ 371 Date: Aug. 24, 2022

(51) Int. Cl. H04W 24/08; H04L 41/147

(52) U.S. Cl. CPC H04W 24/08; H04L 41/147

(57) ABSTRACT

An object of the present disclosure is to provide a communication system and a terminal capable of predicting future communication quality to respond to change in communication quality due to environmental fluctuation.

A system according to the present disclosure includes a surrounding environment information collection unit that acquires surrounding environment information of a communication device performing wireless communication, an object determination unit that uses the surrounding environment information to generate object state information, an input sequence creation unit that classifies the object state information into communication quality prediction categories and generates an input sequence data set, and a communication quality prediction unit that inputs the input sequence data set generated by the input sequence creation unit to a communication quality prediction model obtained by learning a relationship between the object state information including at least one of the type, position, speed, and state of the object and the communication quality prediction category and the communication quality through machine learning, and predicts a current or future communication quality of the communication device.

### TECHNICAL FIELD

The present disclosure relates to a technology for predicting wireless communication quality using environment information.

### BACKGROUND ART

When a device having a wireless communication function (communication device) is used, communication quality is likely to change due to change in a surrounding environment (for example, a movement of an object present in the vicinity), such that services of the device or the communication quality required by a system cannot be satisfied. For example, in IEEE 802.11ad or 5G of cellular communication, because a high frequency in a millimeter band is used, blocking by a shield between transmission and reception during wireless communication becomes a big problem. In wireless communication of not only millimeter waves but also other frequencies, blocking by a shield or change in a propagation environment due to a movement of a reflecting object has an influence on communication quality. In addition, a Doppler shift caused by a movement of a reflecting object also has an influence on communication.

By predicting the communication quality in advance, it is likely that measures will be able to be taken before services and systems become affected. Further, when a model for predicting communication quality is created, it is necessary to take into account that an influence on communication quality changes depending on an operation or material of an object present in the vicinity.

In NPL 1, a depth camera is used to predict the communication quality at the time of blocking of a wireless communication channel in millimeter-wave communication due to passing an object. NPL 1 does not show a case in which a plurality of types of objects having different materials or the like move irregularly because an object, which is a target, is only a person and a movement of the object is constant. Further, effects of a scheme for creating a data set from a plurality of types of object information on prediction accuracy are not mentioned.

### CITATION LIST

### Non Patent Literature

[NPL 1] T. Nishio, H. Okamoto, K. Nakashima, Y. Koda, K. Yamamoto, M. Morikura, Y. Asai, and R. Miyatake, “Proactive Received Power Prediction Using Machine Learning and Depth Images for mm Wave Networks,” IEEE Journal on Selected Areas in Communications, vol. 37, no. 11, pp. 2413-2427, November 2019. doi: 10. 1109/JSAC. 2019. 2933763.
[NPL 2] J. Redmon, A. Farhadi, “YOLOv3: An Incremental Improvement”, CoRR, 2018.
[NPL 3] J. Redmon, A. Farhadi, “YOLOv3: An Incremental Improvement”, CoRR, 2018.

### SUMMARY OF THE INVENTION

### Technical Problem

An object of the present disclosure is to provide a communication system and a terminal capable of predicting future communication quality to respond to change in communication quality due to environmental fluctuation.

### Means for Solving the Problem

A system of the present disclosure includes a surrounding environment information collection unit configured to acquire surrounding environment information of a communication device performing wireless communication; an object determination unit configured to use the surrounding environment information to generate object state information including at least one of a type, position, speed, and state of an object present around the communication device; an input sequence creation unit configured to classify the object state information into communication quality prediction categories classified in advance according to an influence on communication quality of wireless communication, and generate an input sequence data set including at least a part of the object state information generated by the object determination unit and the communication quality prediction category; and a communication quality prediction unit configured to input the input sequence data set generated by the input sequence creation unit to a communication quality prediction model obtained by learning a relationship between the object state information including at least one of the type, position, speed, and state of the object and the communication quality prediction category and the communication quality through machine learning, and predict a current or future communication quality of the communication device.

Here, each of functional units included in the system according to the present disclosure may be included in the same device or may be included in different devices. That is, the system according to the present disclosure includes a device including a surrounding environment information collection unit, an object determination unit, an input sequence creation unit, and a communication quality prediction unit.

A method according to the present disclosure includes acquiring, by a surrounding environment information collection unit, surrounding environment information of a communication device performing wireless communication; using, by an object determination unit, the surrounding environment information to generate object state information including at least one of a type, position, speed, and state of an object present around the communication device; classifying, by an input sequence creation unit, the object state information into communication quality prediction categories classified in advance according to an influence on communication quality of wireless communication, and generating an input sequence data set including at least a part of the object state information generated by the object determination unit and the communication quality prediction category; and inputting, by a communication quality prediction unit, the input sequence data set generated by the input sequence creation unit to a communication quality prediction model obtained by learning a relationship between the object state information including at least one of the type, position, speed, and state of the object and the communication quality prediction category and the communication quality through machine learning, and predicting a current or future communication quality of the communication device.

A device according to the present disclosure includes a surrounding environment information collection unit configured to acquire surrounding environment information of a communication device performing wireless communication; an object determination unit configured to use the surrounding environment information to generate object state information including at least one of a type, position, speed, and state of an object present around the communication device; an input sequence creation unit configured to classify the object state information into communication quality prediction categories classified in advance according to an influence on communication quality of wireless communication, and generate an input sequence data set including at least a part of the object state information generated by the object determination unit and the communication quality prediction category; and a model learning unit configured to use the input sequence data set generated by the input sequence creation unit as input data, learn a relationship between the input sequence data set and a communication quality through machine learning, and generate a communication quality prediction model.

A program according to the present disclosure causes a computer to function as each functional unit included in the device according to the present disclosure. Further, the program causes the computer to execute each step included in the method according to the present disclosure.

### Effects of the Invention

According to the present disclosure, classification of objects is performed in consideration of features (motion, material, and the like) of individuals of objects that have an influence on communication quality depending on a communication environment, and then learning and prediction are performed, so that future communication quality can be predicted, making it possible to respond to change in communication quality due to environmental fluctuation.

### BRIEF DESCRIPTION OF DRAWINGS

FIG. 1 illustrates an example of a communication device according to the present disclosure.

FIG. 2 illustrates an example of a processing flow of a communication quality prediction system according to the present disclosure.

FIG. 3 illustrates an example of object state information.

FIG. 4 illustrates an example of the object state information when tracking is performed.

FIG. 5 illustrates an example of the object state information when tracking is not performed.

FIG. 6 illustrates an example of effects of tracking.

FIG. 7 illustrates an example of effects of dividing into communication quality prediction categories.

FIG. 8 illustrates an example of a configuration of the communication quality prediction system according to the present disclosure.

FIG. 9 illustrates a first configuration example of the communication device.

FIG. 10 illustrates a second configuration example of the communication device.

FIG. 11 illustrates a third configuration example of the communication device.

FIG. 12 illustrates a fourth configuration example of the communication device.

FIG. 13 is an illustrative diagram of an outdoor throughput prediction experiment.

FIG. 14 illustrates an example in which a video obtained in the throughput prediction experiment is acquired.

FIG. 15 illustrates an experimental specification used in the throughput prediction experiment.

FIG. 16 illustrates an example in which the object state information is acquired from surrounding environment information.

FIG. 17 illustrates an example of the object state information obtained in the throughput prediction experiment.

FIG. 18 illustrates an example in which the object state information is acquired from four frames included in a video.

FIG. 19 illustrates communication quality prediction categories used in the throughput prediction experiment.

FIG. 20 illustrates an example of a data sets sorted according to communication quality prediction categories.

FIG. 21 illustrates an example of data before downsampling.

FIG. 22 illustrates an example of data after downsampling.

FIG. 23 illustrates an example of data before speed calculation.

FIG. 24 illustrates an example of data after speed calculation.

FIG. 25 illustrates an example of prediction results in a case in which a bus, truck, vehicle, and person are set as communication quality prediction categories.

### DESCRIPTION OF EMBODIMENTS

Hereinafter, embodiments of the present disclosure will be described in detail with reference to the drawings. The present disclosure is not limited to the embodiments described hereinafter. These embodiments are merely examples, and the present disclosure can be implemented in forms in which various changes and improvements have been made based on knowledge of those skilled in the art. Components having the same reference signs in the present specification and drawings indicate the same components.

The present disclosure assumes a communication system that performs wireless communication between two or more communication devices. For example, a communication quality prediction system according to the present disclosure includes two or more communication devices that perform wireless communication. The present disclosure makes it possible to predict future communication quality to respond to change in communication quality due to environmental fluctuation in a communication system that performs wireless communication.

For a wireless communication system, a wireless LAN defined in IEEE 802.11, Wigig (trade name), IEEE 802.11p, a communication standard for ITS, cellular communication such as LTE or 5G, wireless communication such as a low power wide area (LPWA), or sonic, electrical, or optical communication can be used.

The terminal is hardware capable of any one of control of a movement, operation, and the like of the terminal, control of components of the terminal, and control of communication of the terminal and, for example, automobiles, large mobile vehicles, small mobile vehicles, mining and construction machines, flying moving objects such as drones, two-wheeled vehicles, wheelchairs, or robots is assumed.

Communication quality is an index relevant to quality when at least one of communication units included in the communication device wirelessly communicates with an external communication device. An index relevant to quality of experience (QoE) can be used, such as a received power, a received signal strength indicator (RSSI), a reference signal received quality (RSRQ), a signal to noise ratio (SNR), a signal to interference noise ratio (SINR), a packet loss rate, a data rate, an application quality, an index regarding an increase or decrease in these, and an index obtained by combining two or more of these through linear calculation or the like.

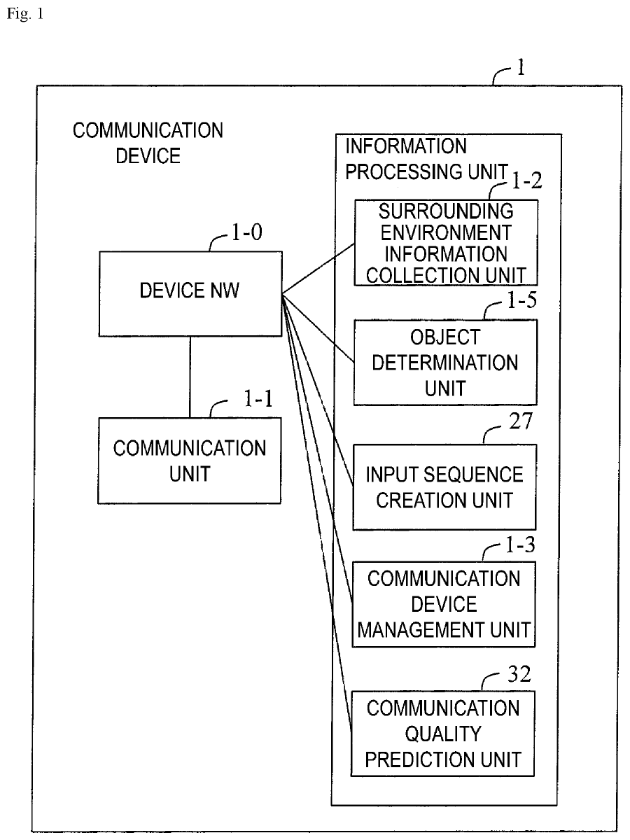

FIG. 1 illustrates an example of the communication device according to the present disclosure. The communication device 1 includes a communication unit 1-1 that performs wireless communication. For the communication unit 1-1, a downlink (transmission from a base station to a mobile terminal), an uplink (transmission from a mobile terminal to a base station), and a side link (transmission from a mobile terminal to a mobile terminal) are assumed, any of these communications can be applied. Further, the communication device 1 according to the present disclosure may be a base station or may be a mobile terminal.

The communication device 1 includes an information processing unit and a device network 1-0. The information processing unit includes a surrounding environment information collection unit 1-2, an object determination unit 1-5, an input sequence creation unit 27, a communication quality prediction unit 32, and a communication device management unit 1-3. The information processing unit may have any functions included in a data collection unit, a learning unit 1-6, and a prediction unit 1-7, which will be described below. Further, each functional unit included in the information processing unit can be connected to each other by the device network 1-0. Each functional unit included in the information processing unit can also be realized by a computer and a program, and a program can be recorded on a recording medium or provided through a network.

When the communication device 1 according to the present disclosure is a base station that predicts communication quality of a downlink or an uplink, the communication device management unit 1-3 acquires and generates communication device state information such as a position of a mobile terminal, which is an external communication device serving as a communication partner, via the communication unit 1-0.

When the communication device 1 according to the present disclosure is a mobile terminal that predicts communication quality of a downlink or an uplink, the communication device management unit 1-3 generates the communication device state information of the communication device 1 itself. In this case, the communication device 1 may collect information such as a position or antenna conditions of a base station serving as a communication partner via the communication unit 1-1, and generate the information in the communication device management unit 1-3.

When the communication device 1 according to the present disclosure is a base station that predicts communication quality of the side link, the communication device management unit 1-3 acquires terminal information of a mobile terminal, which is an external communication device serving as a communication partner, via the communication unit 53, and generates communication device state information such as position information of the communication device 1 itself.

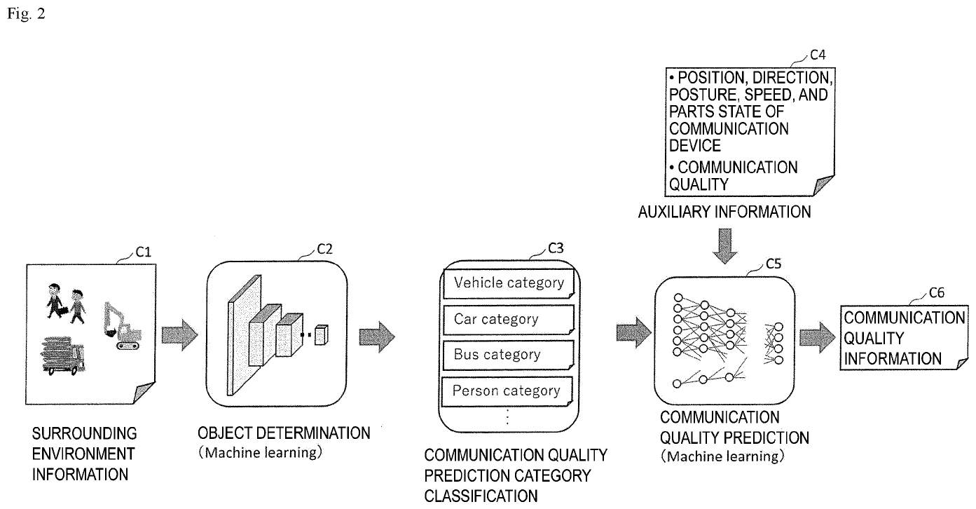

FIG. 2 illustrates an example of a processing flow of the communication quality prediction system according to the present disclosure. The communication quality prediction system according to the present disclosure executes an environment information acquisition step C1, an object determination step C2, a communication quality prediction category classification step C3, an auxiliary information acquisition step C4, and a communication quality prediction step C5. Description of the processing illustrated in FIG. 2 is given hereinafter.

In step C1, the surrounding environment information collection unit 1-2 acquires environment information of the vicinity of one or both of the communication devices (hereinafter referred to as surrounding environment information). Here, the surrounding environment information includes images and videos captured by cameras, any data detected by sensors, and sampling intervals of the sensors or the cameras. Further, the camera or the sensor may be mounted in the communication device 1 or may be included outside the communication device.

In step C2, the object determination unit 1-5 uses an existing object detection scheme to acquire object state information such as a type (class), position, and size of an object present around the communication device from the surrounding environment information obtained in step C1. Here, the class is defined using the object detection scheme and indicates a type of object. The position information is a center position, width, height, contour, or distance (depth) of an object on an angle of view or in a real world. The conversion of the surrounding environment information into the object state information in this way makes it easier for humans to understand, explain, and evaluate the surrounding environment information. Further, when an object detection technology is further improved in the future, it is possible to introduce this technology.

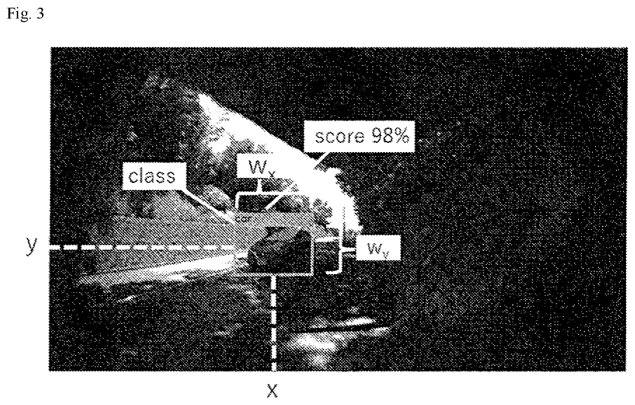

FIG. 3 illustrates an example of the object state information in the object determination unit 12. An example is described in which a video acquired from a camera is used for surrounding environment information. From the video, a class, score, position, and size of an object are output for each frame. For the recognized object, position coordinates (x, y), a width wx, a height wy, a class to which the object belongs, and a score on a screen are output as the object state information. Object score indicates a reliability of an object belonging to a class thereof. In the present example, a case in which an existing object recognition technology YOLOv3 is used is shown (see, for example, NPL 2), whereas in the present disclosure, any one or more object determination models capable of acquiring object state information from surrounding environment information can be used.

Although in a figure in which cubes are arranged in step C2, a case in which deep learning such as a convolutional neural network (CNN) is used when the object state information is acquired from an image is described as an image, other machine learning algorithms may be used. Parameters used in machine learning are learned in advance.

In step C3, the input sequence creation unit 27 classifies the object state information obtained in step C2 into the communication quality prediction category, and generates an input sequence data set including at least a part of the object state information and the communication quality prediction category. Here, classification into the communication quality prediction category may be according to “similarity” of an influence of an object belonging to a certain class on radio wave propagation in a frequency band used in wireless communication, “prone to a detection error” in step C2, and an appearance frequency. Here, “similarity” refers to a case in which a material, size, operation, recognized position, and the like of an object are similar. Further, the object state information may include an amount of change over time obtained by determining whether objects belonging to each class are the same object based on an object detection area (Intersection over Union, or the like) and tracking these. In this case, the classes may overlap or “information categories not used at the time of prediction of communication quality” may be provided.

In step C4, the communication device management unit 1-3 collects information on a position, direction, posture, speed, parts state, and communication quality of the communication device as auxiliary information.

In step C5, the communication quality prediction unit 32 uses the input sequence data set including a part or all of the object state information and the auxiliary information classified into the communication quality prediction categories to predict the communication quality. In step C5, a diagram with a neural network as a motif is shown, but the present invention is not limited thereto, and any other scheme such as machine learning or statistical scheme may be used. Parameters used in machine learning are learned in advance.

Data Storage Based on Tracking

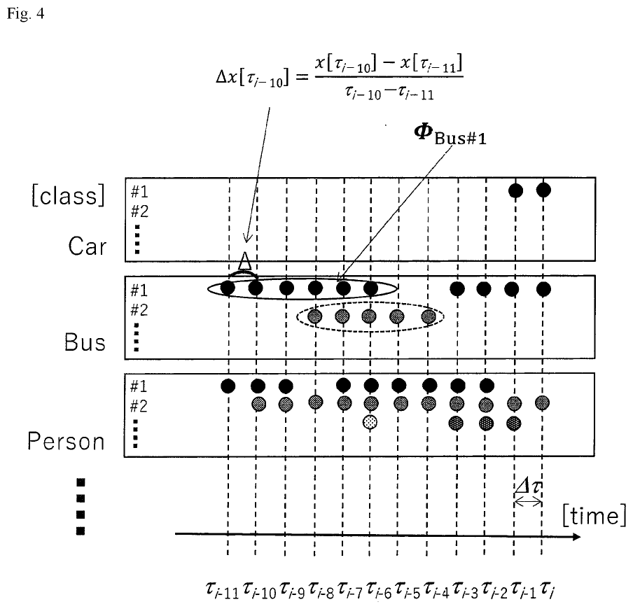

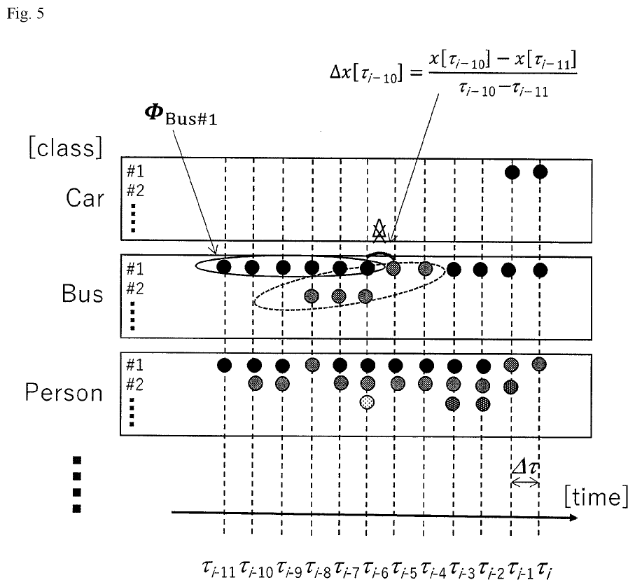

FIGS. 4 and 5 illustrate examples of a data storage method based on tracking and feature amounts that can be acquired. FIG. 4 illustrates a case in which tracking is performed, and FIG. 5 illustrates a case in which tracking is not performed. In FIGS. 4 and 5, Φ_{Bus #1} is a vector indicating object state information of an object belonging to a class “Bus” stored in a first column, and x (an x coordinate of the object), y (a y coordinate), w (width), h (height) and the like are included.

[Math. 1]

Φ_{Bus #1}[τᵢ₋11]=(x[τᵢ₋11],y[τᵢ₋11],w[τᵢ₋11],h[τᵢ₋11], . . . ) (1)

When a speed of the object in an x direction is calculated, it is possible to calculate the speed by calculating the amount of change over time for each column.

$$\begin{matrix}[ Math . 2 ] & \\ Δ x [ {τ}_{i - 10} ] = \frac{x [ {τ}_{i - 10} ] - x [ {τ}_{i - 11} ]}{{τ}_{i - 10} - {τ}_{i - 11}} & ( 2 )\end{matrix}$$

In a case in which tracking is performed, data for the same object is stored in the same column. Thus, it is possible to calculate an amount of change, a median value, an average value, and the like with time for each object and use these as feature amounts. On the other hand, in a case in which tracking is not performed, when a plurality of objects are detected at the same time and belong to the same class, data may be stored in another column even when information is for the same object. Thus, when tracking is not performed, an amount of change may be seen for a different object, and the speed cannot be calculated.

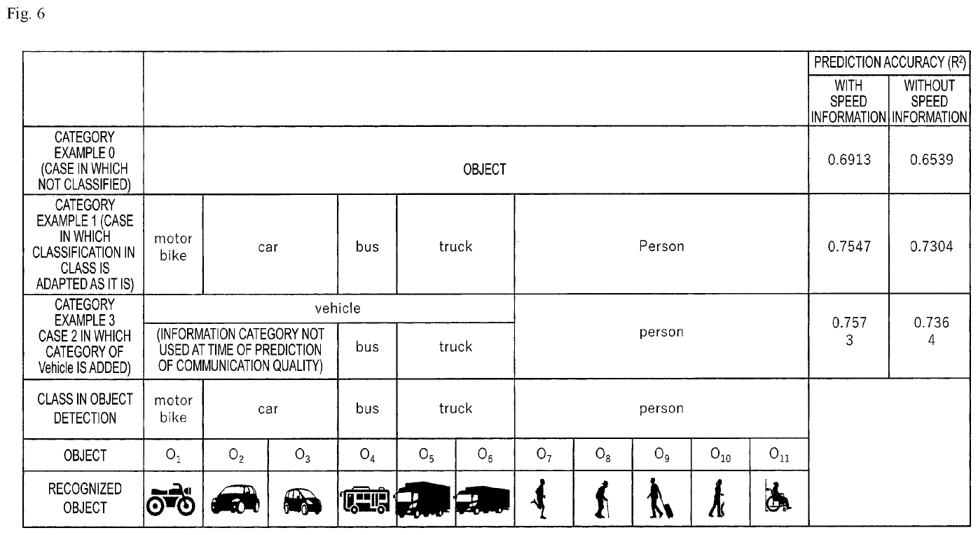

FIG. 6 illustrates an example of effects of tracking. This is a result of learning a relationship between the object state information classified into communication quality prediction categories and the communication quality (throughput) in a random forest and performing evaluation of the result with test data. Comparing a case in which speed information of the object is included in data input to the random forest with a case in which the speed information of the object is not included, it can be seen that prediction accuracy R² in a case in which the speed information is included is higher than in a case in which the speed information is not included. The speed information of the object is extracted through tracking and added to data input to a communication quality prediction model, thereby improving the prediction accuracy.

Here, the prediction accuracy R² is called a determination coefficient and is defined hereinafter.

$$\begin{matrix}[ Math . 3 ] & \\ {R}^{2} = 1 - \frac{{\sum }_{i = 1}^{n} {( B [ t ] - \hat{B} [ t ] )}^{2}}{{\sum }_{i = 1}^{n} {( B [ t ] - \overline{B} )}^{2}} & ( 3 )\end{matrix}$$

B [t]: Measured throughput
B̅: Average of measured throughput
\hat{B}[t]: Predicted throughput

The closer the prediction accuracy R² is to 1, the better the predicted value explains a measured value. Further, it is generally said that “regression is possible” when R²>0.6.

Communication Quality Prediction Category

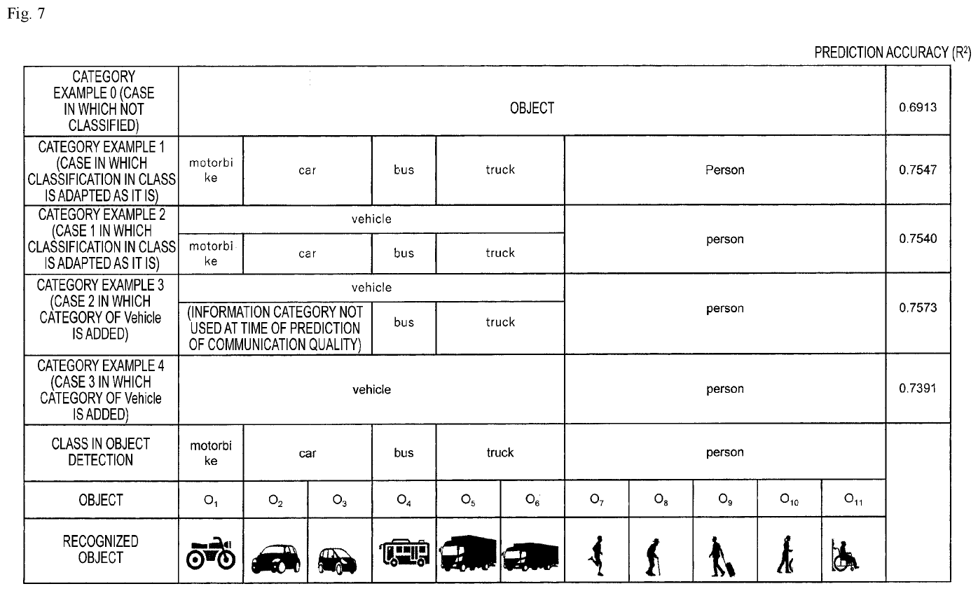

FIG. 7 illustrates an example of effects of the classification into communication quality prediction categories. The relationship between the object state information classified into each communication quality prediction category and the communication quality (throughput) was learned in the random forest, and prediction accuracy (R²) was evaluated using test data.

Effectiveness of the classification of materials is suggested because prediction accuracy in a case in which objects are treated separately according to materials thereof such as metallic objects (vehicles) and living things (persons) is higher than in a case in which all objects are treated equally (category example 0) from a comparison of category example 0 with category example 4. Further, effectiveness of the classification into classes is also suggested by a comparison of category 0 with category 1.

Usefulness of setting of the quality prediction categories in consideration of a material, class, size, and the like of objects for throughput prediction is suggested because the prediction accuracy is improved by provision of dedicated categories (bus and truck) for classes such as buses and trucks that are large in size, which can be expected to have a large influence on radio wave propagation, in addition to the classification according to the materials, as in category 3.

The classification of the object state information into the communication quality prediction categories is a procedure for changing object classification for humans to object classification for communication. From FIG. 6, in the case of any category setting, usefulness of the speed information is suggested because the prediction accuracy (R²) is improved in a case in which the speed information of the object is included at the time of machine learning as compared with a case in which the speed information is not included.

As a specific example of “prone to a detection error”, a method is conceivable in which, objects evaluated as the same object when tracking is performed based on an object detection area (Intersection over Union or the like) for each time frame in the object detection in step C2 are detected as different objects in class detection, and a plurality of classes are detected, the classes are detected as “classes prone to an error”. Further, a method of defining as “prone to an error” when a confidence score output at the time of object detection is smaller than a reference is conceivable. An influence of an object belonging to the class on communication quality is investigated in advance, and a communication quality prediction category corresponding to each class is determined.

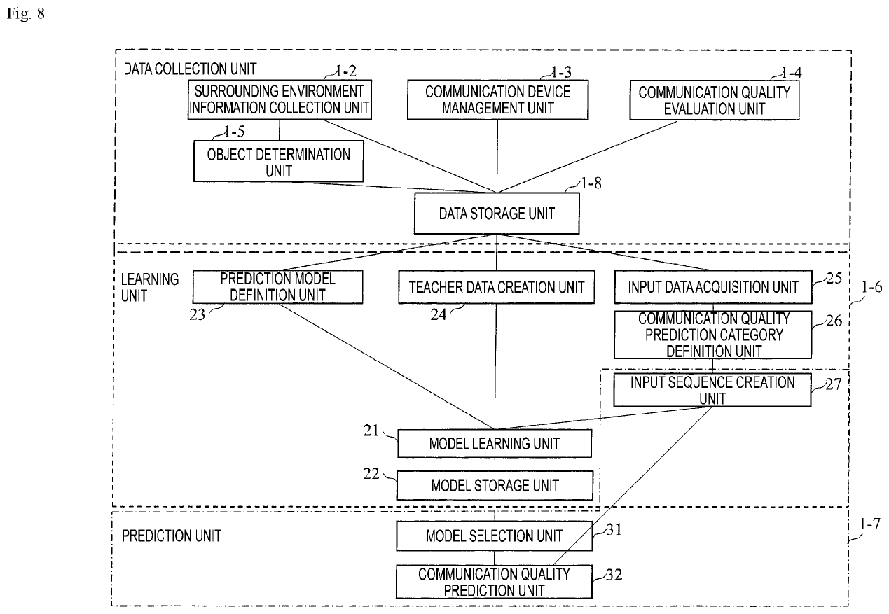

FIG. 8 illustrates an example of a configuration of the communication quality prediction system according to the present disclosure. The communication quality prediction system according to the present disclosure includes a data collection unit, a learning unit 1-6, and a prediction unit 1-7. The data collection unit includes the surrounding environment information collection unit 1-2, the communication device management unit 1-3, the communication quality evaluation unit 1-4, the object determination unit 1-5, and the data storage unit 1-8. The learning unit 1-6 includes a model learning unit 21, a model storage unit 22, a prediction model definition unit 23, a teacher data creation unit 24, an input data acquisition unit 25, a communication quality prediction category definition unit 26, and an input sequence creation unit 27. The prediction unit 1-7 includes a model selection unit 31 and a communication quality prediction unit 32.

Data Collection Unit

The surrounding environment information collection unit 1-2 collects environment information around the terminal (=surrounding environment information) and information on a position in which such information has been acquired (=surrounding environment acquisition position information) using a camera or a sensor.

The communication device management unit 1-3 acquires communication device state information and communication setting information. The communication device state information is information indicating a status of at least one of the communication devices included in the communication device that performs wireless communication, and is information including at least one of a position, direction, and speed of the communication device itself or a communication partner, or both. The communication setting information is information including at least frequency band and channel information used for communication.

The communication quality evaluation unit 1-4 measures the quality of wireless communication between the communication devices.

The object determination unit 1-5 acquires an object determination model such as yolo, and acquires the object state information such as a class, position, speed, and state of an existing object from the surrounding environment information.

The data storage unit 1-8 stores information output from the surrounding environment information collection unit 1-2, the communication device management unit 1-3, the communication quality evaluation unit 1-4, and the object determination unit 1-5.

Learning Unit 1-6

The prediction model definition unit 23 can select a machine learning scheme from among a random forest, a neural network, and the like, and set a structure thereof (the number of layers, the number of nodes, and the like), and set a time of a communication quality prediction destination (how many seconds to predict).

The input data acquisition unit 25 acquires information including at least one of the surrounding environment acquisition position information, the object state information, the communication device state information, and the communication setting information from the data storage unit 1-8, the surrounding environment information collection unit 1-2, the object determination unit 1-5, the communication device management unit 1-3, and the communication quality evaluation unit 1-4. When the input data acquisition unit 25 acquires the object state information, the input data acquisition unit 25 may select information obtained from a camera or sensor installed near the communication device itself or the communication partner based on the communication device state information and acquire the information.

The communication quality prediction category definition unit 26 defines the object state information classified into the communication quality prediction categories for each influence on the communication quality the communication quality prediction category. An example of a definition method is shown hereinafter.

Step S1-1: Classes included in the object state information output from the input data acquisition unit 25 are listed.

Step S1-2: The classes listed in step S1-1 are classified based on a material, size, movement speed, appearance frequency, or the like and a category is created.

Step S1-3: In addition, a category for handling feature amounts other than the object state information, such as throughput information or terminal position, may be set.

Step S2-1: A plurality of patterns of the category classification are prepared based on methods of steps S1-1 to S1-3, and the category pattern with the highest accuracy at the time of learning and predicting using the respective category patterns is adopted.

The creation of the category in step S1-2 includes at least one of a material constituting the object, an operation condition, a detection position, and an appearance frequency, and is performed, for example, as follows.

<Example 1> Because influences of metallic materials and living things on radio wave propagation are different, categories for cars, motorcycles, trucks, and buses, and categories for humans are created. Further, because trucks and buses are considered to be larger in size than other objects and have a good communication channel shielding effect, truck categories and bus categories are further created.

<Example 2> Because trucks appear less frequently than other objects and an amount of learning data is considered to be insufficient, a category for large vehicles is created and buses and trucks with similar shapes or materials are classified into the same category.

The input sequence creation unit 27 classifies the data obtained from the input data acquisition unit 25 into each category defined by the communication quality category definition unit 26, and creates the input sequence data set to be input to the communication quality prediction model. When the object state information is stored in the input sequence data set, for example, an intersection of union (IoU) is calculated for the object detection area, a determination is made as to whether the detected objects are the same for a plurality of consecutive hours, and when the objects are the same, information thereof may be stored in the same column. Further, a time change rate (speed) may be calculated, or a median value or an average value in a time window is calculated for feature amounts stored in the same column so that a feature amount is newly created.

The teacher data creation unit 24 acquires data including at least the communication quality, which is the teacher data when the input sequence data set created by the input sequence creation unit 27 is input to the model, from a database or a communication quality evaluation unit 15.

The model learning unit 21 uses a machine learning model output from the prediction model definition unit 23 to perform learning of the communication quality prediction model from the input sequence data set output from the input sequence creation unit 27 and the teacher data output from the teacher data creation unit 24.

The model storage unit 22 stores the communication quality prediction model learned by the model learning unit 21, the corresponding communication device state information, the communication setting information, and the communication quality prediction category.

Prediction Unit 1-7

The model selection unit 31 selects a communication quality prediction model in which the communication device state information and the communication setting information match. The communication quality prediction unit 32 inputs the input sequence data set created by the input sequence creation unit 27 to the communication quality prediction model selected by the model selection unit 31, and performs prediction of the communication quality.

### System Configuration Example 1

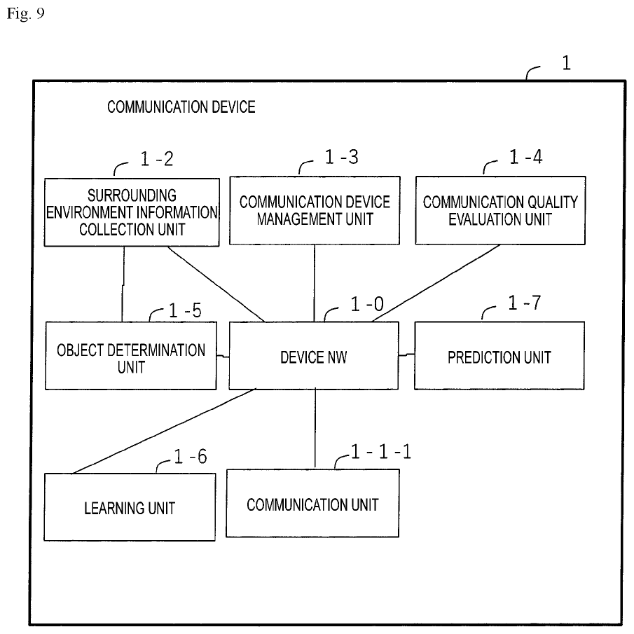

FIG. 9 illustrates a first configuration example of the communication device. A first communication device 1 includes a surrounding environment information collection unit 1-2, a communication device management unit 1-3, a communication quality evaluation unit 1-4, an object determination unit 1-5, a learning unit 1-6, a prediction unit 1-7, and a communication unit 1-1-1 connected by the device network 1-0. In this case, the communication device 1 needs to have a sufficient specification for the object determination unit 1-5 to recognize an object or the learning unit 1-6 to learn the communication quality prediction model. The communication device 1 performs wireless communication with an external communication device.

### System Configuration Example 2

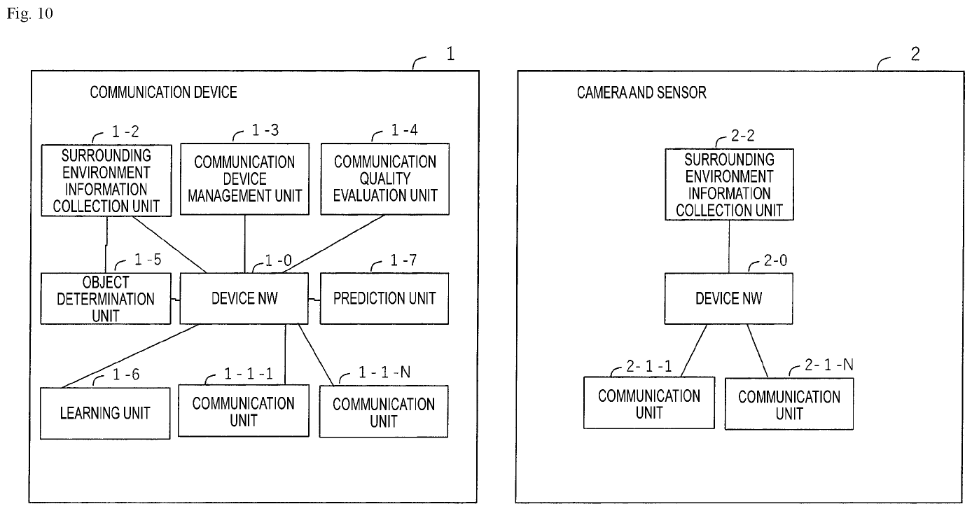

FIG. 10 illustrates a second configuration example of the communication device. The second communication device 1 uses data of a camera and sensor 2 included outside the communication device. In this case, the communication device 1 needs to have a sufficient specification for the object determination unit 1-5 to recognize an object and the learning unit 1-6 to learn the communication quality prediction model. Further, the communication device 1 needs to be connected to the external camera and sensor 2 by a wire or wirelessly.

### System Configuration Example 3

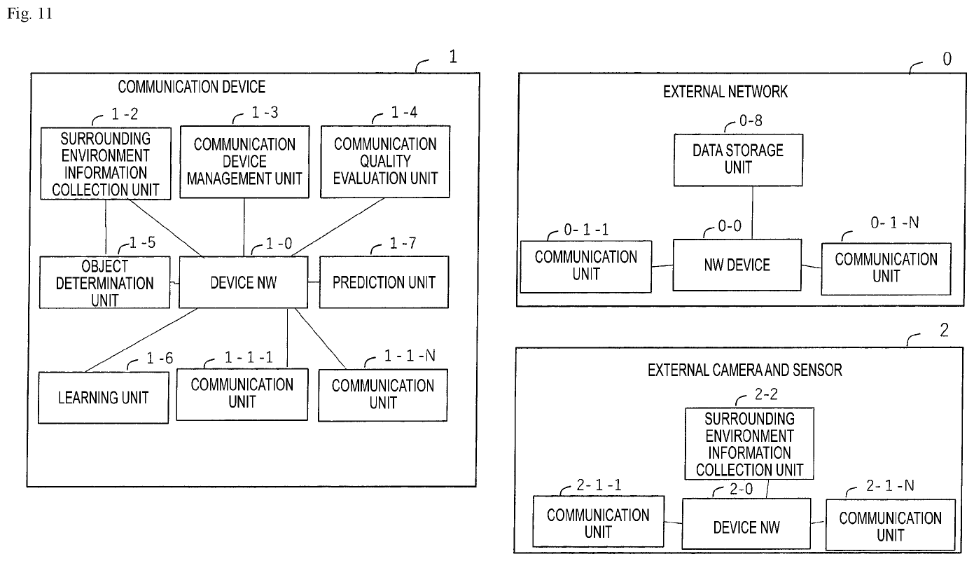

FIG. 11 illustrates a third configuration example of the communication device. Surrounding environment information of the external camera and sensor 2 of the terminal and the communication device 1 is stored in a data storage unit 0-8 of an external network 0. The communication device 1 performs wireless communication with an external communication device. The communication device 1 and the external camera and sensor 2 are connected to the external network 0 by a wire or wirelessly. The learning unit 1-6 included in the communication device 1 performs learning using information stored in the data storage unit 0-8.

### System Configuration Example 4

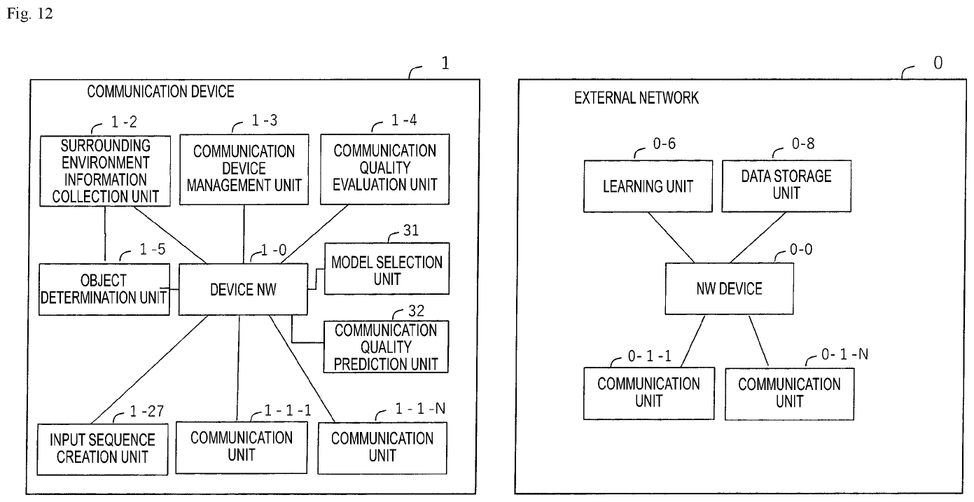

FIG. 12 illustrates a fourth configuration example of the communication device. The communication device 1 uses the communication quality prediction model learned by the learning unit 0-6 connected to the external network 0 to perform prediction. The learning unit 0-6 has the same function as the learning unit 1-6, and uses the information stored in the data storage unit 0-8 to perform learning. The communication device 1 performs wireless communication with the external communication device. The communication device 1 is connected to the external network 0 by a wire or wirelessly. The input sequence creation unit 1-27 classifies the data stored in the data storage unit 0-8 into the communication quality prediction categories, and creates the input sequence data set to be input to the communication quality prediction model. The communication quality prediction unit 1-32 inputs the input sequence data set created by the input sequence creation unit 1-27 to the communication quality prediction model.

### EXAMPLE

An outdoor throughput prediction experiment was conducted.

Experiment Environment

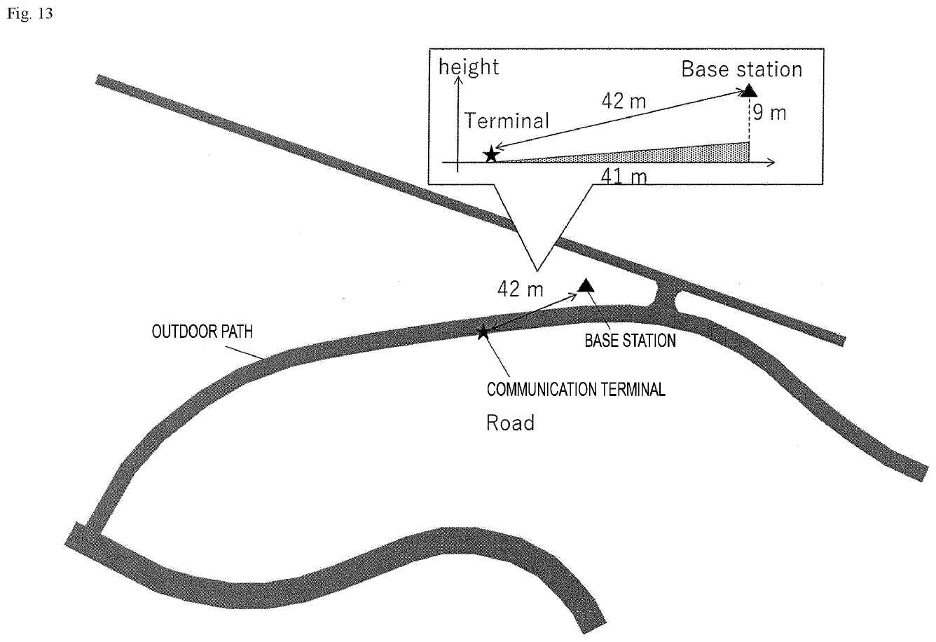

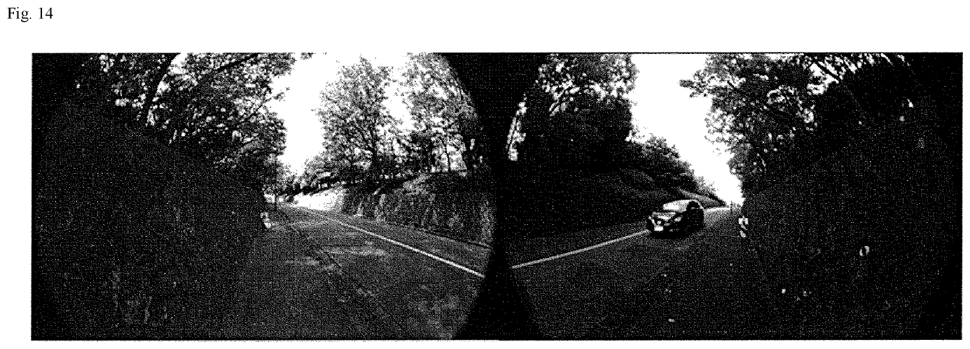

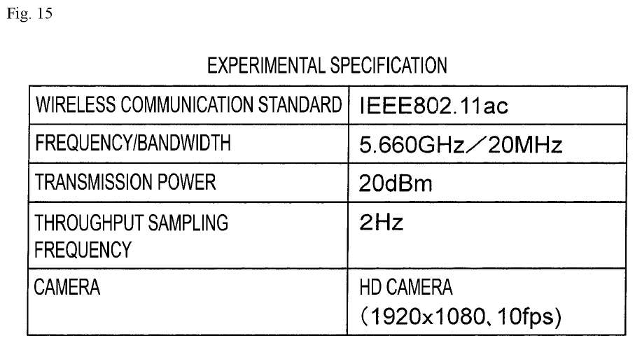

A communication terminal (★ in the drawing) and a base station (♦ in the drawing) were installed on an outdoor road illustrated in FIG. 13. A video of passing vehicles and pedestrians was acquired using two HD cameras installed in the communication terminal while a throughput being measured was at 5.66 GHz. Measurement was performed for one hour. An example of acquisition of the video is illustrated in FIG. 14. For the throughput, a throughput normalized by a median value of a throughput for the past 30 seconds was used, and a change in a throughput due to the object passing through a periphery was measured. The experimental specification is illustrated in FIG. 15.

Object Recognition

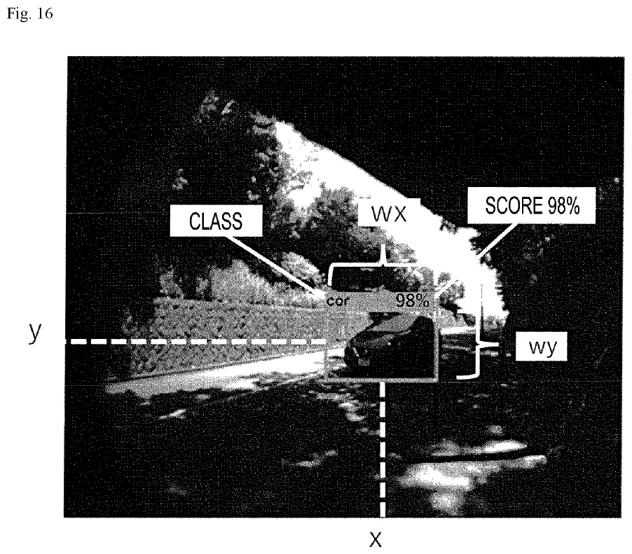

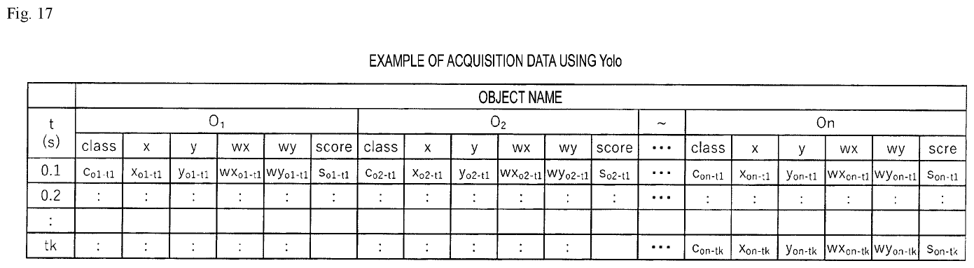

An object recognition technology YOLOv3 (see, for example, NPL 3) was used to output a class, score, position, and size of an object for each frame from the video. For each time t, five parameters including a class, x, y, wx, wy, score as illustrated in FIG. 16 were acquired from respective objects O₁ to Oₙ (n is the number of objects recognized by Yolo). In the present experiment, because a camera video is recorded at 10 fps (10 Hz sampling), an object recognition result can be obtained every 0.1 seconds. FIG. 17 illustrates an example of acquisition data of the object state information.

Determination of Same Object Based on Tracking

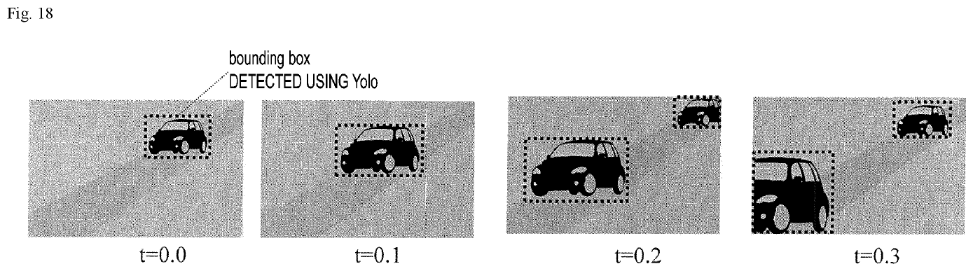

When object recognition is performed on a moving image using Yolo, the recognition is applied to each frame. Thus, the car is recognized from four consecutive frames at time t=0.0 to 0.3 (s) as illustrated in FIG. 18, and a determination cannot be made as to whether the recognized objects are the same in temporally consecutive frames. Thus, the intersection of union (IoU) was used to determine whether the objects are the same.

$$\begin{matrix}[ Math . 4 ] & \\ I o U = \frac{{A}_{intersection}}{{A}_{union}} & ( 4 )\end{matrix}$$

A_{intersection} indicates an area of an overlapped portion of two detected bounding boxes, and Aᵤₙᵢₒₙ indicates a total area of the two bounding boxes. The IoU was calculated for two past frames, and the objects were regarded as being the same when the IoU was equal to or greater than 0.6.

Setting of Communication Quality Prediction Categories

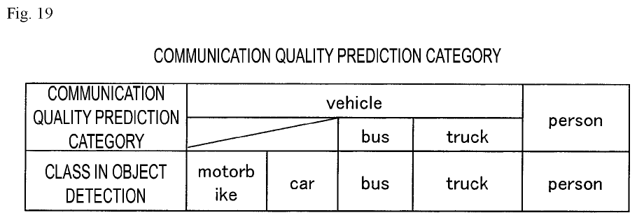

Hereinafter, a case in which a vehicle category and a person category are set as the communication quality prediction categories as illustrated in FIG. 19 will be described. The bus, the truck, and the person indicate groups of objects of which the classes are recognized as a bus, a truck, and a person through object recognition, respectively. Further, the vehicle category indicates objects of which the class is recognized as a motorcycle, a car, a bus, or a truck through object recognition.

Creation of Input Sequence Data Set to Communication Quality Prediction Model

(1) Sorting of Data

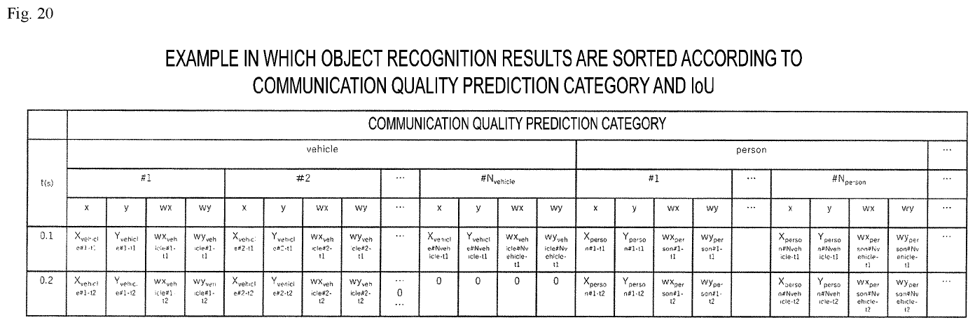

Data of the class included in the communication quality prediction category was extracted from the object state information (FIG. 17) obtained through object recognition, and input sequence data sets sorted according to the communication quality prediction category was created. (FIG. 20)

In FIG. 20, N_{category} (category: vehicle, person, bus, truck) indicates a maximum number of objects belonging to the communication quality prediction category present at the same time. The same index (#N_{category}) is assigned to the objects detected as the same object using the IoU, and object information (x, y, wx, and wy) thereof is stored in the same column.

When there are only fewer objects than N_{category}, 0 is stored. For example, when there are two objects corresponding to the vehicle category at t=0.2, 0 is stored in a column to which an index of #3 to #N_{vehicle} is assigned.

(2) Downsampling

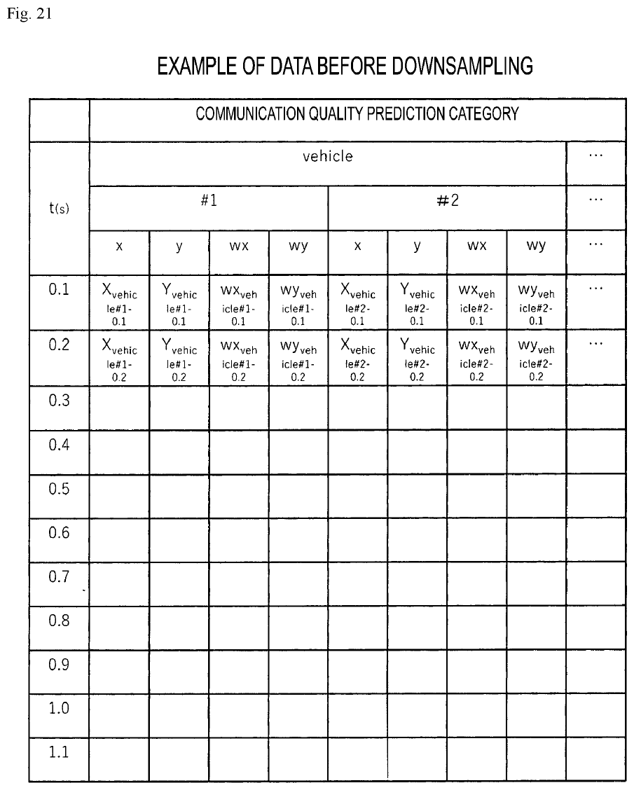

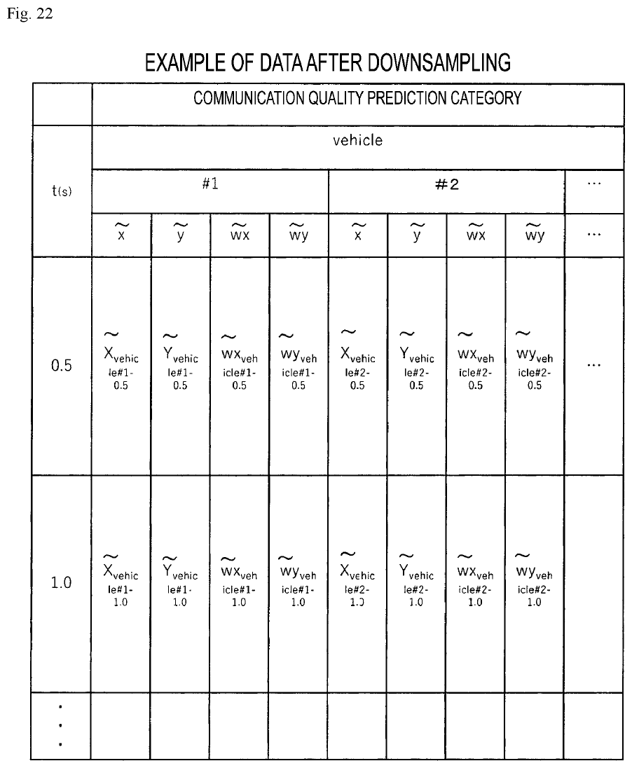

The data sorted in (1) was downsampled from 10 Hz sampling to 2 Hz sampling. 2 Hz sampling data was obtained from a median value every 0.5 s section. An equation for calculating the median value is shown hereinafter using x as an example. FIG. 21 illustrates an example of data before downsampling, and FIG. 22 illustrates an example of data after downsampling.

[Math. 5]

[symbol]

[t]=median(x_{category #N}[t],x_{category #N}[t−0.1],x_{category #N}[t−0.2],x_{category #N}[t−0.3],x_{category #N}[t−0.4]) (5)

(3) Calculation of Speed

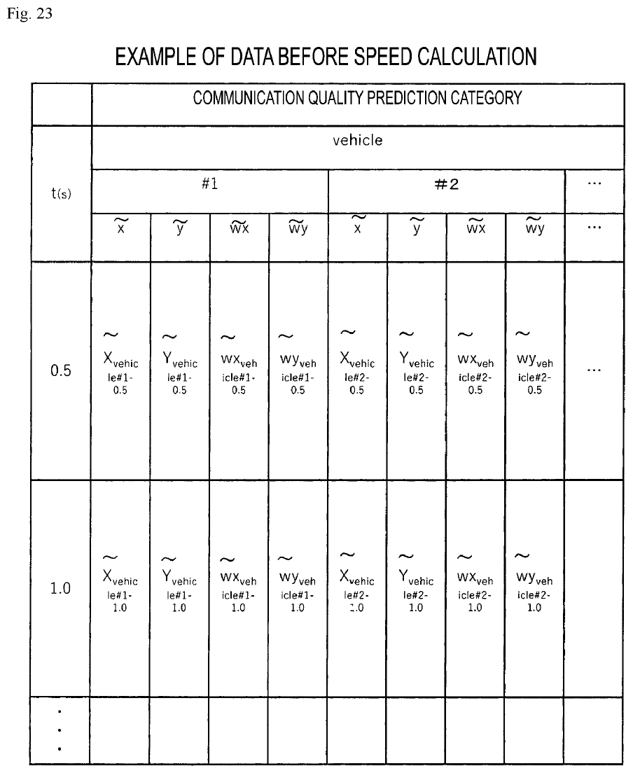

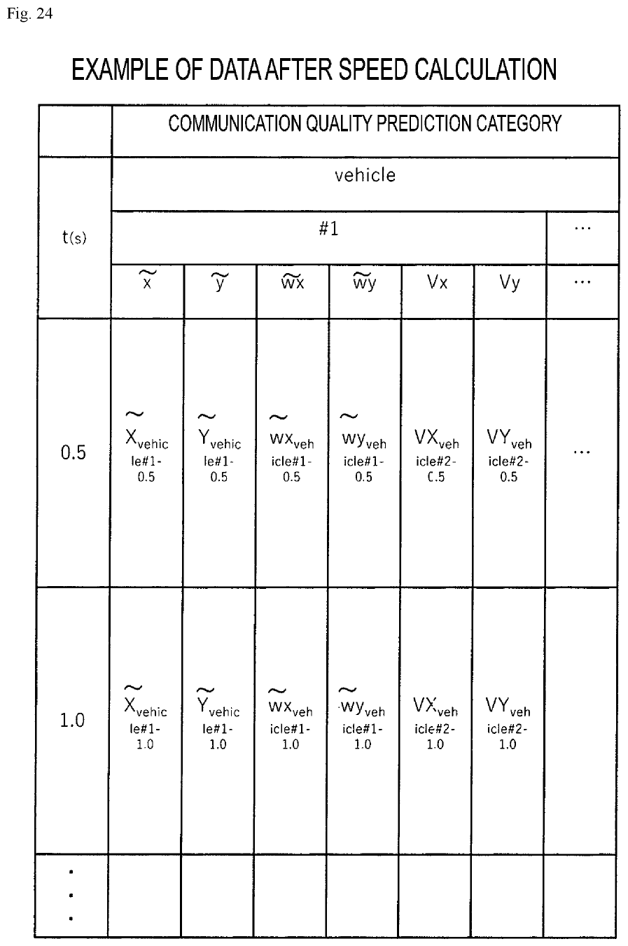

The amount of change over time is calculated for each column for the data created in (2) and added as a feature amount. FIG. 23 illustrates data before speed calculation, and FIG. 24 illustrates an example of data after speed calculation. The feature amount created here corresponds to a speed of the object. The speed is calculated according to the following equation.

$$\begin{matrix}[ Math . 6 ] & \\ Speed & ( 6 )\end{matrix}$$

$$= ( {Vx [ t ]}_{category \# N} , {Vx [ t ]}_{category \# N} )$$

$$= ( \frac{[ t ] - [ t - Δ t ] ,}{Δ t} , \frac{\tilde{{y}_{category \# N}} [ t ] - \tilde{{y}_{category \# N}} [ t - Δ t ]}{Δ t} )$$

Prediction Based on Random Forest

A random forest is used to create a communication quality prediction model. The data after speed calculation illustrated in FIG. 24 was used as an input to the random forest, and the random forest was trained to output a throughput after one second for each time.

For verification, a k-cross validation method was used. In the verification, data obtained from one-hour measurement is divided into k data sets, learning of the random forest is performed using (k−1) data sets among these data sets, and prediction and calculation of R2 are performed from one remaining data set. The evaluation is performed using an average of the k obtained R2 values, and it is assumed that prediction accuracy is higher when the value is larger. In the present experiment, k=5.

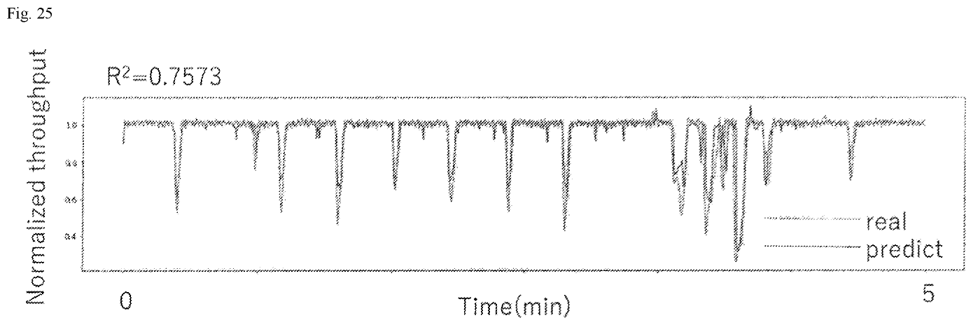

FIG. 25 illustrates an example of prediction results in a case in which bus, truck, vehicle, and person are set as communication quality prediction categories. It can be seen that a predicted value (predict) also decreases with respect to a decrease in a measured real value (real) of the throughput, and the prediction can be made.

Overview of Present Disclosure

The communication system according to the present disclosure collects surrounding environment information around a communication device from cameras, sensors, broadcast information collection devices, and other surrounding environment information collection devices.

The communication system according to the present disclosure uses an object recognition scheme to acquire the object state information such as a type, position, and size of the object from the surrounding environment information.

The communication system according to the present disclosure classifies the object state information into categories that are effective for communication quality prediction (communication quality prediction categories).

The communication system according to the present disclosure models a relationship between data including at least the object state information classified for each communication quality prediction category and the communication quality, through machine learning.

Effects of Present Disclosure

According to the present disclosure, the object state information such as the type, position, and size of an object acquired from the environment information around the terminal using an existing object recognition scheme is classified into the communication quality prediction categories, so that classification can be made from object classification easy for humans to understand to a classification easy to have an influence on quality of wireless communication, and prediction accuracy of communication quality can be improved.

In the present disclosure, a process of converting the environment information around the terminal into the object state information and a process of classifying the object state information into the communication quality prediction categories are separated so that an existing object detection scheme can be used in the former process, and when a higher performance object detection scheme is created, it is easy to replace the existing object detection scheme with such a scheme.

### INDUSTRIAL APPLICABILITY

The present disclosure can be applied to an information and communication industry.

### REFERENCE SIGNS LIST

0: External network
0-0: Network device
1: Communication device
2: External camera and sensor
1-0, 2-0: Device network
0-1-1, 0-1-N, 1-1, 1-1-1, 2-1-1, 2-1-N: Communication unit
1-2, 2-2: Surrounding environment information collection unit
1-3: Communication device management unit
1-4: Communication quality evaluation unit
1-5: Object determination unit
1-6, 0-6: Learning unit
1-7: Prediction unit
1-8, 0-8: Data storage unit
21: Model learning unit
22: Model storage unit
23: Prediction model definition unit
24: Teacher data creation unit
25: Input data acquisition unit
26: Communication quality prediction category definition unit
27, 1-27: Input sequence creation unit
31: Model selection unit
32: Communication quality prediction unit

1. A system comprising:
a surrounding environment information collection unit configured to acquire surrounding environment information of a communication device performing wireless communication;
an object determination unit configured to use the surrounding environment information, and generate object state information including at least one of a type, position, speed, and state of an object present around the communication device;
an input sequence creation unit configured to classify the object state information into a plurality of communication quality prediction categories classified in advance according to an influence on communication quality of wireless communication, and generate an input sequence data set including at least a part of the object state information generated by the object determination unit and the communication quality prediction category; and
a communication quality prediction unit configured to input the input sequence data set generated by the input sequence creation unit to a communication quality prediction model obtained by learning, through machine learning, a relationship between the object state information including at least one of the type, position, speed, and state of the object and the communication quality prediction category and the communication quality, and predict a current or future communication quality of the communication device.

2. The system according to claim 1, further comprising:
a communication quality prediction category definition unit configured to define the object state information classified into the plurality of communication quality prediction categories for every influence on the communication quality,
wherein the object state information includes at least one of a material forming the object, an operation condition, a detection position, and an appearance frequency, and
the communication quality prediction category definition unit uses at least one of the material forming the object detected by the object determination unit, operation condition, detection position, and appearance frequency and defines the plurality of communication quality prediction categories.

3. The system according to claim 2, wherein the communication quality prediction category definition unit temporarily classifies a type of object into the plurality of communication quality prediction categories to determine whether the type of object classified into the communication quality prediction category is appropriate, evaluates prediction accuracy of communication quality, and updates the plurality of communication quality prediction categories to increase prediction accuracy of the communication quality.

4. The system according to claim 1, wherein, when an object likely to be erroneously determined to be a type of another object in the object determination unit is included in the object state information, the input sequence creation unit performs classification into both of a communication quality prediction category corresponding to the object included in the object state information and a communication quality prediction category corresponding to the other object likely to be erroneously determined to be the object.

5. A device comprising:
a surrounding environment information collection unit configured to acquire surrounding environment information of a communication device performing wireless communication;
an object determination unit configured to use the surrounding environment information and generate object state information including at least one of a type, position, speed, and state of an object present around the communication device;
an input sequence creation unit configured to classify the object state information into a plurality of communication quality prediction categories classified in advance according to an influence on communication quality of wireless communication, and generate an input sequence data set including at least a part of the object state information generated by the object determination unit and the communication quality prediction category; and
a communication quality prediction unit configured to input the input sequence data set generated by the input sequence creation unit to a communication quality prediction model obtained by learning, through machine learning, a relationship between the object state information including at least one of the type, position, speed, and state of the object and the communication quality prediction category and the communication quality, and predict a current or future communication quality of the communication device.

6. (canceled)

7. A method comprising:
by a surrounding environment information collection unit, acquiring surrounding environment information of a communication device performing wireless communication;
by an object determination unit, using the surrounding environment information and generating object state information including at least one of a type, position, speed, and state of an object present around the communication device;
by an input sequence creation unit, classifying the object state information into a plurality of communication quality prediction categories classified in advance according to an influence on communication quality of wireless communication, and generating an input sequence data set including at least a part of the object state information generated by the object determination unit and the communication quality prediction category; and
by a communication quality prediction unit, inputting the input sequence data set generated by the input sequence creation unit to a communication quality prediction model obtained by learning, through machine learning, a relationship between the object state information including at least one of the type, position, speed, and state of the object and the communication quality prediction category and the communication quality, and predicting a current or future communication quality of the communication device.

8. (canceled)
